(19) United States
(12) Patent Application Publication
(10) Pub. No.: US 2021/0144628 A1
(43) Pub. Date: May 13, 2021

(54) COMMUNICATION TERMINAL AND METHOD FOR CONTROLLING COMMUNICATION TERMINAL

(71) Applicant: SHARP KABUSHIKI KAISHA, Sakai City, Osaka (JP)

(72) Inventors: MASAAKI MORIYA, Sakai City (JP); MASAFUMI UENO, Sakai City (JP); NAOKI SHIOBARA, Sakai City (JP)

(73) Assignee: SHARP KABUSHIKI KAISHA, Sakai City, Osaka (JP)

(21) Appl. No.: 16/338,951

(22) PCT Filed: May 15, 2017
(86) PCT No.: PCT/JP2017/018236

§ 371 Date: Apr. 2, 2019

(30) Foreign Application Priority Data
Oct. 5, 2016 (JP) 2016-197470

(51) Int. Cl. H04W 48/14; H04W 8/24; H04W 8/00; H04W 4/80; H04W 76/14

(52) U.S. Cl. CPC H04W 48/14; H04W 8/24; H04W 76/14; H04W 4/80; H04W 8/005

(57) ABSTRACT

Notification of a situation in which communication with another terminal is not possible is expressly given to a user. A display apparatus (1) includes an NFC communication unit (112), an NFC controller (13) configured to detect a mobile apparatus (100), a communication mode determination unit (142) configured to determine, when the mobile terminal is detected, whether or not communication with the mobile apparatus based on a P2P mode via an NFC communication unit is possible, and a notification control unit (144) configured to notify that the communication is not possible when it is determined that the communication is not possible.

### TECHNICAL FIELD

The following disclosure relates to a communication terminal configured to perform near field communication with another terminal.

### BACKGROUND ART

In recent years, various services based on near field communication have been developed. Examples of the services are disclosed in PTL 1 and PTL 2.

PTL 1 discloses an automatic teller machine having a transmission/reception function which is wirelessly responsive to a contactless Integrated Circuit (IC) card. When after execution of a transaction, a contactless IC card used for the transaction is present near the automatic teller machine, the automatic teller machine gives guidance that the contactless IC card is left.

PTL 2 discloses an electronic apparatus configured to receive information regarding a state of an apparatus of a communication partner based on near field communication and to cause a display unit to display the information to cause transition to a mode corresponding to the information.

### CITATION LIST

### Patent Literature

PTL 1: Japanese Patent Application Publication No. 2000-48245 (publication date: Feb. 18, 2000)

PTL 2: Japanese Patent Application Publication No. 2015-211412 (publication date: Nov. 24, 2015)

### SUMMARY OF INVENTION

### Technical Problem

According to the techniques of PTL 1 and PTL 2, however, the guidance or the display is performed after wireless communication between two terminals, and the guidance or the display is not performed in a state where the communication is impossible. Thus, according to the techniques of PTL 1 and PTL 2, when the state where the communication is impossible occurs, a user cannot be aware of the occurrence of such a state, and therefore, the user may not be able to recognize causes of the state and/or take any measures to resolve the state.

Thus, an object in the following disclosure is to realize a communication terminal configured to notify a user of a state where a specific type of communication with another terminal is not possible.

### Solution to Problem

To solve the problem, a communication terminal according to one aspect of the present disclosure includes: a communication unit configured to perform near field communication; a detection unit configured to detect another terminal; a determination unit configured to determine, when the detection unit detects the another terminal, whether or not a specific type of communication with the another terminal via the communication unit is possible; and a notification unit configured to, when the determination unit determines that the communication is not possible, notify that the communication is not possible.

Moreover, to solve the problem, a method for controlling a communication terminal according to one aspect of the present disclosure is a method for controlling a communication terminal including a communication unit configured to perform near field communication, the method including, a detection step of detecting another terminal, a determination step of determining, when the another terminal is detected in the detection step, whether or not a specific type of communication with the another terminal via the communication unit is possible, and a notification step of notifying, when it is determined in the determination step that the communication is not possible, that the communication is not possible.

### Advantageous Effects of Invention

The communication terminal according to the one aspect of the present disclosure and the method for controlling the communication terminal have the effect that it is possible to notify a user of a state where a specific type of communication with another terminal is not possible.

### BRIEF DESCRIPTION OF DRAWINGS

FIG. 1 is a functional block diagram illustrating a configuration of a main part of a display apparatus according to a first embodiment of the present disclosure.

FIG. 2 is a view illustrating a specific configuration of an NFC display of the display apparatus according to the first embodiment of the present disclosure.

FIG. 3 is a flow chart illustrating an example of a process in the display apparatus according to the first embodiment of the disclosure.

FIG. 4 is a view illustrating a display example in the display apparatus according to the first embodiment of the present disclosure, wherein (a) is a view illustrating a display example in a case where a mobile apparatus is not held over the NFC display, and (b) is a view illustrating a display example in a case where a mobile apparatus is held over the NFC display and a P2P mode of the mobile apparatus is disabled.

FIG. 5 is a functional block diagram illustrating a configuration of a main part of a display apparatus according to a second embodiment of the present disclosure.

FIG. 6 is a view illustrating a specific configuration of an NFC display of the display apparatus according to the second embodiment of the present disclosure.

FIG. 7 shows (a) and (b) which are views illustrating a principle of a touch panel shown in FIG. 6 and (c) and (d) which are views illustrating examples of a sensor signal generated when an object comes into contact with the touch panel.

FIG. 8 is a flow chart illustrating an example of a process in the display apparatus according to the second embodiment of the disclosure.

FIG. 9 is a view illustrating a display example in the display apparatus according to the second embodiment of the present disclosure, wherein (a) is a view illustrating a display example in a case where a mobile apparatus is not held over the NFC display, and (b) is a view illustrating a display example in a case where a mobile apparatus is held over the NFC display and an NFC communication function of the mobile apparatus is disabled.

FIG. 10 is a flow chart illustrating an example of a process in a display apparatus according to a third embodiment of the disclosure.

FIG. 11 is a view illustrating a display example in the display apparatus according to the third embodiment of the present disclosure, wherein (a) is a view illustrating a display example in a case where neither an NFC-equipped mobile apparatus nor a non NFC-equipped mobile apparatus is held over a touch panel, and (b) is a view illustrating a display example in a case where a non NFC-equipped mobile apparatus is held over the touch panel.

FIG. 12 is a flow chart illustrating an example of a process in a display apparatus according to a fourth embodiment of the disclosure.

### DESCRIPTION OF EMBODIMENTS

### First Embodiment

In each of the following embodiments, an example of a data process based on near field communication will be described with reference to FIGS. 1 to 4.

Note that the near field communication refers to short-range wireless communication in general. The near field communication includes communication based on a Radio Frequency IDentification (RFID) technique, for example, a contactless IC card or a contactless IC tag. In the present embodiment, it may be understood that the term “communication” means near field communication unless otherwise specifically indicated. In each of the following embodiments, Near Field Communication (NFC) will be described as an example of the near field communication.

### Schema of Display Apparatus 1

First, with reference to FIGS. 1 and 2, a schema of a display apparatus (communication terminal) 1 will be described. FIG. 1 is a functional block diagram illustrating a configuration of a main part of the display apparatus 1 of the present embodiment. FIG. 2 is a view illustrating a specific configuration of an NFC display 11 of the display apparatus 1 according to the present embodiment.

The display apparatus 1 is an apparatus configured to display images and includes, as illustrated in FIG. 1, an NFC display 11, an NFC controller (detection unit) 13, a control unit 14, and a storage unit 15. The display apparatus 1 may be used as, for example, a digital signage apparatus.

The NFC display 11 is a display including a mechanism that performs near field communication with a mobile apparatus (another terminal) 100 which will be described later. The NFC display 11 includes a protection glass 110, an NFC communication unit (communication unit) 112, and a display unit (notification unit) 113.

Here, a specific configuration of the NFC display 11 will be described with reference to FIG. 2. As illustrated in FIG. 2, the NFC display 11 includes the protection glass 110, the NFC communication unit 112, and the display unit 113 superimposed on one another in this order from a side on which a user visually perceives an image.

The NFC communication unit 112 is a communication device for performing near field communication with the mobile apparatus 100. Note that the mobile apparatus 100 is an apparatus having a function of performing near field communication (NFC communication) with the display apparatus 1 and is, for example, a mobile phone such as a smartphone or a tablet computer. In other words, the mobile apparatus 100 has an NFC communication function (communication function) that enables communication with the NFC communication unit 112.

The NFC communication unit 112 includes an NFC antenna 114 (antenna) which is a transparent antenna having a function of sensing the mobile apparatus 100 and transmitting/receiving data. Specifically, as illustrated in FIG. 2, the NFC communication unit 112 is a sheet-like member disposed between the protection glass 110 and the display unit 113. Note that as illustrated in FIG. 2, the NFC communication unit 112 of the present embodiment includes one NFC antenna 114, but the number, the size, and the location of the NFC antenna 114 are not limited to those in the example in FIG. 2. Moreover, the location of the NFC communication unit 112 is not limited to the location between the protection glass 110 and the display unit 113 shown in FIG. 2. For example, the NFC communication unit 112 may be disposed on a rear surface of the display unit 113 (that is, on an opposite side of the side on which a user visually perceives an image), and in this case, the NFC antenna does not have to be transparent. Moreover, in the present embodiment, the NFC communication unit 112 and the display unit 113 are superimposed on each other, but the NFC communication unit and the display unit do not necessarily have to be superimposed on each other.

The display unit 113 is a display device configured to display each of pieces of information supplied from the control unit 14 as an image in a display area. The display unit 113 is, for example, a Liquid crystal display (LCD) but is not limited to this example. Note that the display apparatus 1 includes the display unit 113 as the notification unit, but the communication terminal according to one aspect of the present disclosure is not limited to this embodiment. That is, as long as the notification unit is configured to notify a user of information processed by the display apparatus 1, the notification unit may include, for example, a Light Emitting Diode (LED) or a loudspeaker. Moreover, the notification unit may include a combination of a display apparatus, an LED, a loudspeaker, and the like.

The NFC controller 13 is a detection unit configured to detect the mobile apparatus 100. More specifically, the NFC controller 13 detects whether or not the mobile apparatus 100 is held over the NFC display 11. In the present embodiment, the NFC controller 13 receives a Find command to which a prescribed parameter issued by the control unit 14 has been added, and in accordance with the Find command and the prescribed parameter, the NFC controller 13 drives the NFC communication unit 112 (NFC antenna 114) to attempt to detect the mobile apparatus 100.

More specifically, the NFC controller 13 continuously outputs a request signal as a wireless signal (weak radio wave) via the NFC communication unit 112 to the outside. The request signal is a signal for requesting media information for specifying the type of the mobile apparatus 100 (that is, a signal for detecting the mobile apparatus 100). The media information is stored in the mobile apparatus 100. Then, the NFC controller 13 performs checking of whether or not a response to the request signal is given within a prescribed time after the request signal is output. The NFC controller 13 transmits, to a response signal detection determination unit 141, a result of the checking as a result of an attempt at the detection. These operations performed by the NFC controller 13 are controlled by the response signal detection determination unit 141 which will be described later.

Moreover, the NFC controller 13 executes a transmission/reception process of prescribed data between the display apparatus 1 and the mobile apparatus 100 via the NFC communication unit 112. The operation performed by the NFC controller 13 is controlled by a transmission process execution unit 143 which will be described later.

The control unit 14 comprehensively controls components of the display apparatus 1 and, for example, controls the display unit 113, controls the NFC controller 13, and starts or controls software (applications) stored in the storage unit 15. The control unit 14 is connected to be able to communicate with the NFC display 11 and the NFC controller 13. Note that a specific configuration of the control unit 14 will be described later. Moreover, the storage unit 15 stores various types of data to be used by the display apparatus 1.

Note that functions of components of the control unit 14 shown in FIG. 1 may be realized by an external apparatus provided independently of the display apparatus 1. In this case, the external device functions as a communication terminal having the functions of the above-described components and being configured to cooperate with the display apparatus 1 to perform near field communication with the mobile apparatus 100. Moreover, the display apparatus 1 and the external device perform transmission/reception of data via a transmission/reception unit (not shown). The transmission/reception of the data may be performed in a wired or wireless manner. Alternatively, the display apparatus 1 and the external device may perform transmission/reception of data via a relay apparatus such as a router.

### Specific Configuration of Control Unit 14

Next, with reference to FIG. 1, a specific configuration of the control unit 14 will be described.

The control unit 14 includes the response signal detection determination unit (detection unit) 141, a communication mode determination unit (determination unit) 142, the transmission process execution unit 143, and a notification control unit (notification unit) 144.

The response signal detection determination unit 141 controls the NFC controller 13 to perform, together with the NFC controller 13, checking of whether or not the mobile apparatus 100 is held over the NFC display 11. That is, in the present embodiment, the response signal detection determination unit 141 has a function as a detection unit which, together with the NFC controller 13, detects the mobile apparatus 100.

In the present embodiment, the response signal detection determination unit 141 determines whether or not a response signal as a response to the request signal transmitted to the mobile apparatus 100 is detected, thereby performing the checking. In this case, the response signal detection determination unit 141 issues the Find command to which a prescribed parameter has been added for the NFC controller 13, and the response signal detection determination unit 141 transmits the Find command to the NFC controller 13.

Specifically, the response signal detection determination unit 141 causes the NFC controller 13 to continuously issue the request signal for requesting media information stored in the mobile apparatus 100. As described above, the NFC controller 13 outputs the request signal issued as a wireless signal via the NFC communication unit 112 to the outside, thereby checking whether or not a response from the mobile apparatus 100 is given, and the NFC controller 13 returns a result of the checking, to the response signal detection determination unit 141.

When the mobile apparatus 100 is held over the NFC display 11, the mobile apparatus 100 receives the request signal, and within the prescribed time, the mobile apparatus 100 transmits the response signal in response to the request signal to the display apparatus 1. The NFC controller 13 receives the response signal via the NFC communication unit 112 within the prescribed time and transmits the reception of the response signal as the result of the checking to the response signal detection determination unit 141.

Here, the NFC controller 13 receives the response signal by the number of mobile apparatuses 100 held over the NFC display 11. For example, when one mobile apparatus 100 is held over the NFC display 11, the NFC controller 13 transmits, as the result of the checking, data denoting that the number of detection apparatuses (detection media count) is one to the response signal detection determination unit 141. That is, when receiving data denoting that the number of detection apparatuses is more than one, the response signal detection determination unit 141 determines that the NFC controller 13 has detected the response signal.

On the other hand, when the mobile apparatus 100 is not held over the NFC display 11, or when a mobile apparatus having no NFC communication function is held over the NFC display 11, the NFC controller 13 cannot receive the response signal in response to the request signal. Thus, in this case, the NFC controller 13 transmits, to the response signal detection determination unit 141, that no response signal is received (that is, data denoting that the number of detection apparatuses is 0) as the result of the checking after the prescribed time has elapsed. Thus, the response signal detection determination unit 141 determines that the NFC controller 13 has detected no response signal.

When the response signal detection determination unit 141 determines that the mobile apparatus 100 is held over the NFC display 11 (that is, when the NFC controller 13 detects the mobile apparatus 100), the communication mode determination unit 142 determines whether or not a specific type of communication with the mobile apparatus 100 via the NFC communication unit 112 is possible. In the present embodiment, the communication mode determination unit 142 determines whether or not communication based on a Peer to Peer (P2P) mode as the specific type of communication is possible.

In the NFC, for example, communication based on the P2P mode, communication based on a reader/writer mode, or communication based on a card emulation mode is possible. The P2P mode is a mode which enables various types of data to be transmitted between two apparatuses having NFC communication functions. To directly transmit data between the apparatuses via the NFC communication unit, the P2P mode has to be enabled. It can be said that the P2P mode is a mode which enables transmission/reception of various types of data between mobile apparatuses having the NFC communication function, that is, a mode which enables bi-directional communication with the mobile apparatus 100. On the other hand, the reader/writer mode is a mode which enables data to be read from or written to an NFC card and/or a NFC tag. Moreover, the card emulation mode is a mode in which an apparatus having the NFC communication function is usable as the NFC card and/or the NFC tag. That is, the reader/writer mode and the card emulation mode are modes in which uni-directional communication between mobile apparatuses having the NFC communication function is possible but are not modes in which the bi-directional communication is possible.

In the present embodiment, when it is determined that the response signal detection determination unit 141 detects the response signal, the communication mode determination unit 142 analyzes the response signal received by the NFC controller 13.

In the present embodiment, when the mobile apparatus 100 receives the request signal via the NFC communication unit 112, the mobile apparatus 100 incorporates media information containing a media type denoting a communication scheme of the mobile apparatus 100 into the response signal and transmits the response signal to the display apparatus 1. Thus, when the P2P mode is set as the communication mode of the mobile apparatus 100, the response signal includes media information containing a media type denoting that a communication scheme is the P2P mode. On the other hand, when a communication mode other than the P2P mode is set as the communication mode of the mobile apparatus 100, the response signal includes media information containing a media type denoting that a communication scheme is a communication mode other than the P2P mode.

Thus, the communication mode determination unit 142 analyzes the response signal to check whether or not the media information contained in the response signal denotes the P2P mode, thereby determining whether or not communication with the mobile apparatus 100 held over the NFC display 11 based on the P2P mode is possible.

When the communication mode determination unit 142 determines that the communication based on the P2P mode is possible, the communication mode determination unit 142 determines that the P2P mode is enabled in the mobile apparatus 100, and the communication mode determination unit 142 notifies the transmission process execution unit 143 that the P2P mode is enabled. On the other hand, when the communication mode determination unit 142 determines that the communication based on the P2P mode is not possible, the communication mode determination unit 142 determines that the P2P mode is disabled in the mobile apparatus 100, and the communication mode determination unit 142 notifies the notification control unit 144 that the P2P mode is disabled.

Note that methods for determination of detection of the mobile apparatus 100 by the above-described NFC controller 13 and the response signal detection determination unit 141 and for determination of the communication scheme by the communication mode determination unit 142 are mere examples and are not limited to these examples as long as these determinations are made.

When the communication mode determination unit 142 determines that communication based on the P2P mode is possible, the transmission process execution unit 143 executes the transmission/reception process of the prescribed data between the display apparatus 1 and the mobile apparatus 100. For example, the transmission process execution unit 143 executes the transmission process of the prescribed data from the display apparatus 1 to the mobile apparatus 100.

When the communication mode determination unit 142 determines that the communication based on the P2P mode is not possible, the notification control unit 144 causes the display unit 113 to notify that the communication based on the P2P mode is not possible. That is, the notification control unit 144, together with the display unit 113, functions as a notification unit for performing the notification. In the present embodiment, the notification control unit 144 outputs, to the display unit 113, an image containing a message that prompts a user to enable the P2P of the mobile apparatus 100 (that is, a message showing a countermeasure to be taken by a user), thereby notifying the user of the mobile apparatus 100 of the countermeasure.

When the notification unit is realized by one or more LEDs in place of the display unit 113, the notification control unit 144 performs the notification by, for example, controlling lighting of the LEDs. In this case, instructions describing countermeasures to be taken by a user when the LEDs are lit are preferably indicated at a location, for example, in the vicinity of the display unit 113, easily viewed by the user. Alternatively, when the notification unit is realized by a loudspeaker, the notification control unit 144 may output monotonous sound such as buzzer sound from the loudspeaker to perform the notification. In this case, similarly to the case of the LEDs being lit, instructions describing countermeasures to be taken by a user when the buzzer sound is output from the loudspeaker are preferably indicated at the above-described location. Alternatively, the notification control unit 144 may output voice containing the contents (the countermeasures) of the notification, in place of the buzzer sound, from the loudspeaker. Alternatively, the notification unit may be realized by a combination of the above-described members, and in this case, the notification may be performed by a combination of the above-described notifications. For example, when the notification unit includes the display unit 113 and a loudspeaker, an image including a message showing the countermeasure may be displayed in the display unit 113, and voice containing the message may be output from the loudspeaker.

### Process in Display Apparatus 1 in Present Embodiment

Next, with reference to FIG. 3, an example of a process (control method) in the display apparatus 1 according to the present embodiment will be described. FIG. 3 is a flow chart illustrating the example of the process in the display apparatus 1 according to the present embodiment.

First, the NFC controller 13 and the response signal detection determination unit 141 check whether or not a response from the mobile apparatus 100 is given via the NFC communication unit 112 (NFC antenna 114) (S1). In the present embodiment, the response signal detection determination unit 141 controls the NFC controller 13, thereby checking whether or not the NFC controller 13 receives the response signal in response to the request signal (that is, whether or not the number of detection apparatuses is larger than 1) to check whether or not the response is given.

That is, through the process in S, it is determined whether or not a mobile apparatus 100 is held over the NFC display 11. Moreover, it can be said that in the present embodiment, the process in S1 is a process (detection step) of detecting the mobile apparatus 100 by the NFC controller 13 and the response signal detection determination unit 141.

If the response signal detection determination unit 141 determines that the response from the mobile apparatus 100 is given (if YES is determined in S1), it is determined whether or not the communication mode of the mobile apparatus 100 is set to the P2P mode (S2; determination step). In the present embodiment, the communication mode determination unit 142 analyzes media information contained in the response signal received by the NFC controller 13 to determine whether or not the P2P mode of the mobile apparatus 100 is enabled. On the other hand, if it is determined that no response is given in S1 (if NO is determined in S1), the process in S1 is repeated until the response is given (until the mobile apparatus 100 is held over the NFC display 11).

When the communication mode determination unit 142 determines that the P2P mode of the mobile apparatus 100 is enabled, that is, when it is determined that communication with the mobile apparatus 100 based on the P2P mode is possible (YES is determined in S2), the transmission process execution unit 143 performs the transmission/reception process of the prescribed data to/from the mobile apparatus 100 (S3). In the present embodiment, for example, the transmission process execution unit 143 executes the transmission process of the prescribed data to the mobile apparatus 100.

On the other hand, when the communication mode determination unit 142 determines that the P2P mode of the mobile apparatus 100 is not enabled, that is, when it is determined that communication with the mobile apparatus 100 based on the P2P mode is not possible (NO is determined in S2), the notification control unit 144 notifies that the communication is not possible via the display unit 113 (S4; notification step). In the present embodiment, the notification control unit 144 displays a message for prompting enabling of the P2P mode of the mobile apparatus 100 in the display unit 113. Then, the process returns to the process in S.

When after the process in S4, a user enables the P2P mode of the mobile apparatus 100 and holds the mobile apparatus 100 over the NFC display 11 again, the response from the mobile apparatus 100 is given in S1, and in the process in S2, it is determined that the P2P mode of the mobile apparatus 100 is enabled. Thus, in the process in S3, the transmission/reception process of the prescribed data is executed.

### Display Example in Present Embodiment

Next, with reference to FIG. 4, a display example of the display apparatus 1 according to the present embodiment will be described. FIG. 4 is a view illustrating the display example of the display apparatus 1 according to the present embodiment, wherein (a) is a view illustrating a display example in a case where the mobile apparatus 100 is not held over the NFC display 11 and (b) is a view illustrating a display example in a case where the mobile apparatus 100 is held over the NFC display 11 and a P2P mode of the mobile apparatus 100 is disabled. The present example shows a display example in a case where the mobile apparatus 100 acquires prescribed data stored in the display apparatus 1.

As illustrated in (a) of FIG. 4, when the mobile apparatus 100 is not held over the NFC display 11, control by the control unit 14 in the display apparatus 1 displays, in the display unit 113, a message M1 (in the present example, “touch to obtain information”) for prompting a user to hold the mobile apparatus 100 over the NFC display 11 (that is, that the prescribed information is available) and an image containing a position P1 where the mobile apparatus 100 is to be held over the NFC display 11. The control unit 14 displays the image in the display unit 113, for example, in a case where transmission of data is performed based on the NFC communication.

In a state in (a) of FIG. 4, when the mobile apparatus 100 is held over the position P1 of the NFC display 11 by a user who checks the message M1, as described above, the NFC controller 13 and the response signal detection determination unit 141 in the display apparatus 1 detect the mobile apparatus 100 and determine whether or not the P2P mode of the mobile apparatus 100 is enabled. When it is determined that the P2P mode is not enabled, as illustrated in (b) of FIG. 4, an image including a message M2 (in the present example, “Please turn on the P2P mode for NFC”) denoting that the P2P mode is not enabled is displayed. That is, when it is determined that the P2P mode is not enabled, the notification control unit 144 switches the message M1 to the message M2, and thereby, it is possible to prompt a user of the mobile apparatus 100 to enable the P2P mode of the mobile apparatus 100.

### Main Effect of First Embodiment

As described above, the display apparatus 1 according to the present embodiment determines whether or not communication via the NFC communication unit 112 with the mobile apparatus 100 based on the P2P mode is possible, and when the communication is not possible, the display apparatus 1 notifies that the communication is not possible. Thus, a user can be aware of the possibility that the P2P mode of the mobile apparatus 100 is disabled. Thus, it is possible for a user to change the setting of the communication mode of the mobile apparatus 100 so that the P2P mode is enabled, thereby causing the display apparatus 1 to communicate with the mobile apparatus 100.

On the other hand, when the mobile apparatus 100 with the P2P mode being enabled is held over the NFC display 11, the above-described notification is not performed. This enables the display apparatus 1 to smoothly communicate with the mobile apparatus 100.

### Second Embodiment

Another embodiment of the present disclosure will be described below with reference to FIGS. 5 to 9. Note that for the sake of description, members having the same functions as the members described in the embodiment are denoted by the same reference signs, and the description thereof will be omitted.

### Schema of Display Apparatus 1A

First, with reference to FIGS. 5 and 6, a display apparatus 1A according to the present embodiment will be described. FIG. 5 is a functional block diagram illustrating a configuration of a main part of the display apparatus 1A according to the present embodiment. FIG. 6 is a view illustrating a specific configuration of an NFC display 11A of the display apparatus 1A according to the present embodiment.

As illustrated in FIG. 5, the display apparatus 1A includes the NFC display 11A and a control unit 14A respectively in place of the NFC display 11 and the control unit 14 of the display apparatus 1 in the first embodiment. The display apparatus 1A further includes a touch panel controller (detection unit) 12.

As illustrated in FIGS. 5 and 6, the NFC display 11A includes a touch panel (detection unit) 111 in addition to the components of the NFC display 11 in the first embodiment. Specifically, as illustrated in FIG. 6, the NFC display 11A includes members, namely, a protection glass 110, an NFC communication unit panel 112, the touch panel 111, and a display unit 113 superimposed on one another in this order from a side on which a user visually perceives images.

Note that in the NFC display 11A of the present embodiment, the NFC communication unit 112 and the touch panel 111 have to overlap each other. Alternatively, the NFC communication unit 112 may be disposed on the touch panel 111 (that is, the touch panel 111 and the NFC communication unit 112 may be integrated with each other). Alternatively, in the present embodiment, the display unit 113 overlaps the NFC communication unit 112 and the touch panel 111, but the display unit 113 does not necessarily have to overlap the NFC communication unit 112 and the touch panel 111.

The touch panel 111 is a detection unit configured to detect various objects including a mobile apparatus 100. The touch panel 111 includes a touch surface for receiving a contact of an object and a detection mechanism for detecting the contact between the object and the touch surface and an input position thereof. A system of the detection mechanism of the touch panel may be, for example, an infrared system, an electrostatic capacitance system, an infrared camera system, a two-bar system, a resistor film system, or the like depending on differences between detection principles. Note that in the present embodiment, description is provided assuming that the detection mechanism of the touch panel 111 is a detection mechanism of the electrostatic capacitance system. The touch panel 111 does not come into contact with an object, but the distance between the touch panel 111 and the object is within a prescribed distance, and the touch panel 111 may be configured to detect a so-called proximity state as contact. Note that the operation of the touch panel 111 is controlled by the touch panel controller 12 which will be described later.

Here, the capacitive touch panel 111 will be described in detail with reference to FIG. 7. In FIG. 7, (a) and (b) are views illustrating a principle of the touch panel 111, and in FIG. 7, (c) and (d) are views illustrating examples of a detection signal generated when an object comes into contact with the touch panel 111.

As illustrated in (a) of FIG. 7, the touch panel 111 includes a transparent electrode 115 extending in the Y direction and a transparent electrode 116 extending in the X direction which are stacked on each other. As illustrated in (b) of FIG. 7, when an object (in (b) of FIG. 7, a finger F) having conductivity comes into contact with the touch panel 111, electrostatic capacitance changes. At this time, a point between electrodes between which the electrostatic capacitance changes is detected, and thereby, it is possible to specify a coordinate representing a location where the object comes into contact with the touch panel 111.

In FIG. 7, (c) and (d) are views illustrating examples of the detection signal illustrating the variation of the electrostatic capacitance when the mobile apparatus 100 having the NFC communication function (in this embodiment, description is provided assuming that a housing of the mobile apparatus 100 does not have conductivity) as the object is brought into contact with the touch panel 111. Note that the mobile apparatus 100 includes an antenna coil for realizing the NFC communication function, and the touch panel 111 can detect contact of the mobile apparatus 100 based on the conductivity of the antenna coil.

When the mobile apparatus 100 is brought into contact with the touch panel 111, a detection signal as shown in (c) of FIG. 7 is generated. When the detection signal is shown in a top view, it can be seen as shown in (d) of FIG. 7 that a sensor signal is generated in a form of a contact surface of the mobile apparatus 100 (surface in contact with the touch panel 111). Specifically, a sensor signal having a shape corresponding to the shape of the antenna coil is generated. As described above, in a capacitive touch panel 111, even when the NFC communication function of the mobile apparatus 100 is disabled, an NFC antenna 114 is a dielectric, and the antenna coil has substantially similar size and shape, and therefore, it is possible to detect from information obtained by the touch panel 111, whether or not the mobile apparatus 100 is in contact with the touch panel 111.

The touch panel 111 outputs the sensor signal as the detection signal to the touch panel controller 12. Specifically, the touch panel 111 outputs the detection signal to the touch panel controller 12 at a frequency of 60 to 240 times per second.

Note that although not shown, when an object such as a finger comes into contact with the touch panel 111, a sensor signal (in other words, broad sensor signal) in a wide range as illustrated in (c) of FIG. 7 is not generated, but a sensor signal in a narrow range (in other words, narrow sensor signal) is generated.

Returning to FIG. 5, the touch panel controller 12 is configured to control the operation of the touch panel 111. Specifically, the touch panel controller 12 detects the mobile apparatus 100 based on an analysis result of the detection signal (sensor signal generated when the touch panel 111 detects an object) denoting that the touch panel 111 detects an object such as the mobile apparatus 100. That is, it can be said that the touch panel controller 12 also has a function as the detection unit. The touch panel controller 12 outputs information regarding whether or not the mobile apparatus 100 is detected to a terminal presence/absence determination unit 145 which will be described later.

Note that similarly to the first embodiment, functions of components of the control unit 14A shown in FIG. 5 may be realized by an external apparatus (communication terminal) provided independently of the display apparatus 1A.

### Specific Configuration of Control Unit 14A

The control unit 14A comprehensively controls components of the display apparatus 1A and controls the touch panel controller 12 in addition to the control unit 14 of the first embodiment. The control unit 14A and the NFC display 11A are connected to each other to be able to communicate with each other.

Moreover, the control unit 14A includes a response signal detection determination unit (determination unit) 141, a communication mode determination unit 142, a transmission process execution unit 143, a notification control unit 144, and the terminal presence/absence determination unit (detection unit) 145. That is, the control unit 14A includes the terminal presence/absence determination unit 145 in addition to the components of the control unit 14 of the first embodiment.

The terminal presence/absence determination unit 145 controls the touch panel controller 12, and thereby, the terminal presence/absence determination unit 145, together with the touch panel controller 12, checks whether or not the NFC display 11A is touched with a mobile apparatus 100 having the NFC communication function.

As described above, the touch panel controller 12 is capable of detecting the mobile apparatus 100 based on an analysis result of the detection signal. Thus, when the terminal presence/absence determination unit 145 receives, from the touch panel controller 12, a detection result denoting that the mobile apparatus 100 is detected, the terminal presence/absence determination unit 145 determines that the NFC display 11A is touched with the mobile apparatus 100. On the other hand, when the terminal presence/absence determination unit 145 receives, from the touch panel controller 12, a detection result denoting that the mobile apparatus 100 is not detected, the terminal presence/absence determination unit 145 determines that the NFC display 11A is not touched with the mobile apparatus 100. That is, in the present embodiment, the terminal presence/absence determination unit 145 has a function as a detection unit which, together with the touch panel 111 and the touch panel controller 12, detects the mobile apparatus 100.

Moreover, regardless of whether the NFC communication function of the mobile apparatus 100 is enabled or disabled (that is, whether the NFC communication function is in operation or is stopped), the touch panel controller 12 analyzes the detection signal, and thereby, it is possible to detect the mobile apparatus 100. Thus, even when the response signal detection determination unit 141 determines that the mobile apparatus 100 is not held over the NFC display 11A, it is possible to determine that the NFC display 11A is touched with the mobile apparatus 100 by the touch panel controller 12 and the terminal presence/absence determination unit 145. That is, even when the NFC communication function is disabled, it is possible to detect the mobile apparatus 100 with which the NFC display 11A is touched.

In the present embodiment, when the response signal is not detected by the response signal detection determination unit 141, the presence/absence of the mobile apparatus 100 is determined by the terminal presence/absence determination unit 145.

When the terminal presence/absence determination unit 145 determines that the NFC display 11A is touched with the mobile apparatus 100 (that is, when the mobile apparatus 100 is detected by the touch panel 111 and the touch panel controller 12), the response signal detection determination unit 141 determines whether or not a specific type of communication with the mobile apparatus 100 via the NFC communication unit 112 is possible. In the present embodiment, the response signal detection determination unit 141 determines whether or not NFC communication, as the specific type of communication, by receiving the response signal from the mobile apparatus 100 to a request signal is possible.

That is, the response signal detection determination unit 141 in the first embodiment functions as a detection unit configured to detect the mobile apparatus 100, but the response signal detection determination unit 141 in the present embodiment functions as a determination unit configured to determine whether or not the communication (NFC communication) is possible. In the present embodiment, the communication mode determination unit 142 determines whether or not communication based on a P2P mode as the specific type of communication is possible, provided that NFC communication is possible.

In a case (1) where the communication mode determination unit 142 determines that the communication based on the P2P mode is not possible, similarly to the first embodiment, the notification control unit 144 causes the display unit 113 to notify that the communication based on the P2P mode is not possible. Alternatively, in a case (2) where the terminal presence/absence determination unit 145 determines that the NFC display 11A is touched with the mobile apparatus 100, and the response signal detection determination unit 141 determines that the NFC communication is not possible, the notification control unit 144 causes the display unit 113 to notify that the NFC communication is not possible. In the present embodiment, the notification control unit 144 outputs an image including a message prompting a user of the mobile apparatus 100 to enable the NFC communication function of the mobile apparatus 100 (that is, a message showing a countermeasure to be taken by a user) to notify the user of the countermeasure.

When the NFC controller 13 cannot receive the response signal in response to the request signal despite that the touch panel 111 detects the mobile apparatus 100, it is assumed that the NFC communication function of the mobile apparatus 100 is disabled (off). Thus, in the case (2) described above, the notification to a user is made so that the user enables (turns on) the NFC communication function, which makes it possible to use the NFC communication.

### Process in Display Apparatus 1A in Present Embodiment

Next, with reference to FIG. 8, an example of a process in the display apparatus 1A according to the present embodiment will be described. FIG. 8 is a flow chart illustrating the example of the process in the display apparatus 1A according to the present embodiment.

First, similarly to the first embodiment, the response signal detection determination unit 141 determines the presence or absence of the response from the mobile apparatus 100 in S. If the response signal detection determination unit 141 determines that the response from the mobile apparatus 100 is not given (if NO is determined in S1), the response signal detection determination unit 141 notifies the terminal presence/absence determination unit 145 of the absence of the response. When the terminal presence/absence determination unit 145 receives the notification from the response signal detection determination unit 141, the touch panel 111 determines whether or not the mobile apparatus 100 is detected (S11).

That is, in the present embodiment, the process in S11 is a process (detection step) of detecting the mobile apparatus 100 by the touch panel controller 12 and the terminal presence/absence determination unit 145. In other words, the process of detecting whether or not the NFC display 11A is touched with the mobile apparatus 100 is, in the present embodiment, performed by the touch panel controller 12 and the terminal presence/absence determination unit 145 but not by the NFC controller 13 and the response signal detection determination unit 141 in S1.

Alternatively, in the process in S1, when it is determined that the response from the mobile apparatus 100 is given, communication (NFC communication) via the NFC communication unit 112 is performed. On the other hand, when the response from the mobile apparatus 100 is not given, the NFC communication is not performed. Thus, it can be said that in the present embodiment, the process in S1 is a process (determination step) of determining whether or not performing of NFC communication as the specific type of communication is possible.

If the response signal detection determination unit 145 determines that the mobile apparatus 100 is detected (if YES is determined in S11), the notification control unit 144 causes the display unit 113 to notify that the NFC communication is not possible (S12; notification step). That is, when the mobile apparatus 100 is detected in a state where the NFC communication is not possible, it is assumed that the function is disabled although the mobile apparatus 100 having the NFC communication function is held over the NFC display 11A. Thus, when NO is determined in the process in S1 and YES is determined in the process in S11, it is determined that the NFC communication function of the mobile apparatus 100 detected is disabled, and the above-described notification is performed. In the present embodiment, the notification control unit 144 causes the display unit 113 to display a message for prompting enabling of the communication function of the mobile apparatus 100. Then, the process returns to the process in S1.

When after the process in S12, a user enables the NFC communication function of the mobile apparatus 100 and holds the mobile apparatus 100 over the NFC display 11A again, the NFC controller 13 and the response signal detection determination unit 141 can receive a response from the mobile apparatus 100 in the process in S1, and therefore, it is determined that the NFC communication with the mobile apparatus 100 is possible.

On the other hand, when the mobile apparatus 100 is not detected in S11 (NO is determined in S11), the process returns to the process in S1. In this case, it is possible to determine that the mobile apparatus 100 is not held over the NFC display 11A.

Note that the processes in S2 to S4 are similar to those of the first embodiment, and thus, the description thereof is omitted here.

### Display Example in Present Embodiment

Next, with reference to FIG. 9, a display example of the display apparatus 1A according to the present embodiment will be described. FIG. 9 is a view illustrating the display example of the display apparatus 1A according to the present embodiment, wherein (a) is a view illustrating a display example in a case where the mobile apparatus 100 is not held over the NFC display 11A and (b) is a view illustrating a display example in a case where the mobile apparatus 100 is held over the NFC display 11A and an NFC communication function of the mobile apparatus 100 is disabled. Similarly to the first embodiment, the present example shows a display example in a case where the mobile apparatus 100 acquires prescribed data stored in the display apparatus 1A. Note that the state shown in (a) of FIG. 9 is similar to that shown in (a) of FIG. 4 of the first embodiment, and thus, the description thereof is omitted here.

In the state shown in (a) of FIG. 9, when a user who checks the message M1 touches the position P1 of the NFC display 11A is touched with the mobile apparatus 100 whose NFC communication function is not enabled, the display apparatus 1A cannot detect the mobile apparatus 100 by the NFC controller 13 and the response signal detection determination unit 141 as described above, but the touch panel 111 detects the mobile apparatus 100. That is, it is determined that the NFC communication function of the mobile apparatus 100 detected is disabled. Thus, in this case, as illustrated in (b) of FIG. 9, an image including a message M3 (in the present example, “Please turn on the NFC communication function”) denoting that the NFC communication is not possible is displayed. That is, when it is determined that the NFC communication function of the mobile apparatus 100 is not enabled, the notification control unit 144 switches the message M1 to the message M3, and thereby, it is possible to prompt a user of the mobile apparatus 100 to enable the NFC communication function of the mobile apparatus 100.

### Main Effect of Second Embodiment

As described above, the display apparatus 1A according to the present embodiment determines whether or not NFC with the mobile apparatus 100 is possible, and when the NFC communication is not possible, it is notified that the NFC communication is not possible. Specifically, when the touch panel 111 detects the mobile apparatus 100 and the NFC communication with the mobile apparatus 100 is not possible, the display apparatus 1A notifies that the NFC communication is not possible. Thus, a user can be aware of the possibility that the NFC communication function of the mobile apparatus 100 is disabled. Thus, a user enables the NFC communication function of the mobile apparatus 100 to cause the display apparatus 1A to communicate with the mobile apparatus 100.

On the other hand, when the mobile apparatus 100 with NFC communication function being enabled is held over the NFC display 11A, the above-described notification is not performed. This enables the display apparatus 1A to smoothly communicate with the mobile apparatus 100.

When the NFC communication function of the mobile apparatus 100 is enabled, a process similar to the first embodiment is performed. Thus, in this case, effects similar to those in the first embodiment are obtained.

### Third Embodiment

Another embodiment of the present disclosure will be described below with reference to FIGS. 10 to 11. Note that for the sake of description, members having the same functions as the members described in the embodiment are denoted by the same reference signs, and the description thereof will be omitted.

Note that a display apparatus according to the present embodiment has a similar configuration to the display apparatus 1A according to the second embodiment shown in FIG. 5. Similarly to the second embodiment, a terminal presence/absence determination unit 145 functions as a detection unit which, together with a touch panel 111 and a touch panel controller 12, detects a mobile apparatus 100. Moreover, a response signal detection determination unit 141 functions as a determination unit configured to determine whether or not NFC is possible.

As described in the second embodiment, the terminal presence/absence determination unit 145 is configured to determine, based on analysis of a detection signal of the touch panel 111 by the touch panel controller 12, whether an object which comes into contact with or comes close to the touch panel 111 is the mobile apparatus 100 having the NFC communication function or a mobile apparatus having no NFC communication function (non NFC-equipped (NFC-incompatible) mobile apparatus).

Specifically, the mobile apparatus 100 has an NFC communication unit (NFC antenna). On the other hand, the non NFC-equipped mobile apparatus includes no NFC antenna. Thus, the touch panel controller 12 is configured to obtain the detection signal reflecting the material and the shape of an NFC antenna 114 in the case of mobile apparatus 100 based on the above-described analysis, but in the case of the non NFC-equipped mobile apparatus, such a detection signal cannot be obtained. For example, when a housing of the non NFC-equipped mobile apparatus includes a metal frame, at least the disposition location of the metal frame and the disposition location of the NFC antenna are different. Moreover, depending on the presence/absence of the NFC antenna, the internal configuration of the mobile apparatus varies. Thus, the detection signal obtained is different between the mobile apparatus 100 and the non NFC-equipped mobile apparatus. Thus, based on the above-described analysis, the terminal presence/absence determination unit 145 is configured to determine whether or not the mobile apparatus with which the touch panel 111 is touched has the NFC communication function.

That is, it can be said that in the second embodiment and the present embodiment, the terminal presence/absence determination unit 145 functions as a communication function presence/absence determination unit configured to determine, based on the detection signal, whether or not the mobile apparatus (another terminal) held over an NFC display 11A has the NFC communication function.

When the terminal presence/absence determination unit 145 determines that the mobile apparatus 100 is held over the NFC display 11A (that is, when the touch panel 111 detects the mobile apparatus 100) and when the response signal detection determination unit 141 determines that the NFC communication is not possible, similarly to the second embodiment, a notification control unit 144 causes a display unit 113 to notify that the NFC communication is not possible.

In the present embodiment, when the touch panel 111 detects a non NFC-equipped mobile apparatus, the notification control unit 144 causes the display unit 113 to notify, in addition to the above-described notification, that the mobile apparatus does not have the NFC communication function. In the present embodiment, the notification control unit 144 outputs an image including a communication scheme which is other than NFC and which is assumed to be able to perform data communication with the mobile apparatus. Examples of the communication scheme other than the NFC include a QR code (registered trademark).

### Process in Display Apparatus 1A in Present Embodiment

Next, with reference to FIG. 10, an example of a process in a display apparatus 1A according to the present embodiment will be described. FIG. 10 is a flow chart illustrating the example of the process in the display apparatus 1A according to the present embodiment. Note that processes S1 to S4 and a process in S12 are similar to those of the display apparatus 1A according to the second embodiment shown in FIG. 8, and thus, the description of thereof is omitted here.

In the second embodiment, when the touch panel 111 does not detect the mobile apparatus 100 in the process in S11 shown in FIG. 8, the process returns to the process in S. That is, in the second embodiment, even when the mobile apparatus held over the NFC display 11A has no NFC communication function, and even when no object is actually held over the NFC display 11A, the process returns to the process in S1. On the other hand, in the present embodiment, it is checked in S22 whether or not the object detected by the touch panel 111 is the non NFC-equipped mobile apparatus, and a process according to the check result is performed.

Specifically, if the response signal detection determination unit 141 determines that the response from the mobile apparatus (mobile apparatus 100 or non NFC-equipped mobile apparatus) is not given (if NO is determined in S), the terminal presence/absence determination unit 145 determines whether or not the mobile apparatus 100 (NFC mobile apparatus) is detected by the touch panel 111 (S21). Then, if the response signal detection determination unit 145 determines that the mobile apparatus 100 is detected (if YES is determined in S21), the process proceeds to the process in S12, and notification (for example, notification that prompts the NFC communication function to be enabled) is performed by the notification control unit 144.

On the other hand, if the response signal detection determination unit 145 determines that the mobile apparatus 100 is not detected (if NO is determined in S21), the touch panel 111 determines whether or not the non NFC-equipped mobile apparatus is detected (S22). Then, if the response signal detection determination unit 145 determines that the non NFC-equipped mobile apparatus is detected (if YES is determined in S22), the notification control unit 144 notifies that the non NFC-equipped mobile apparatus has no NFC communication function (S23: notification step). In the present embodiment, the notification control unit 144 causes the display unit 113 to display an image including a communication scheme which is other than NFC and with which the mobile apparatus is compatible. Then, the process proceeds to the end. On the other hand, if the response signal detection determination unit 145 determines that the non NFC-equipped mobile apparatus is not detected (if NO is determined in S22), the process returns to the process in S1.

As described above, the process in S21 is, similar to the process in S11, a detection step of detecting the mobile apparatus 100. On the other hand, it can be said that the process in S22 is a detection step of detecting a mobile apparatus as another terminal different from the mobile apparatus 100. Moreover, it can be said that the processes in S21 and S22 are communication function presence/absence determination steps of determining whether or not the mobile apparatus with which the touch panel 111 is touched has the NFC communication function.

### Display Example in Present Embodiment

Next, with reference to FIG. 11, a display example of the display apparatus 1A according to the present embodiment will be described. FIG. 11 is a view illustrating the display example in the display apparatus 1A according to the present embodiment, wherein (a) is a view illustrating a display example in a case where the touch panel 111 is touched with neither the mobile apparatus 100 nor a non NFC-equipped mobile apparatus, and (b) is a view illustrating a display example in a case where the touch panel 111 is touched with a non NFC-equipped mobile apparatus. The present example shows a display example in a case where the non NFC-equipped mobile apparatus acquires prescribed data stored in the display apparatus 1A. Note that a state shown in (a) of FIG. 11 is similar to that shown in (a) of FIG. 9 of the second embodiment, and thus, the description thereof is omitted here.

In the state shown in (a) of FIG. 11, when the position P1 of the NFC display 11A is touched with the non NFC-equipped mobile apparatus by a user who checks the message M1, the display apparatus 1A cannot detect the mobile apparatus by an NFC controller 13 and the response signal detection determination unit 141 as described above, but the touch panel 111 detects the mobile apparatus. Then, the terminal presence/absence determination unit 145 determines that the mobile apparatus thus detected is the non NFC-equipped mobile apparatus. Thus, in this case, as illustrated in (b) of FIG. 11, an image including a message M4 (in the present example, a QR code (registered trademark) as a communication scheme other than the NFC) denoting that the NFC communication function is not provided. That is, the notification control unit 144 switches the message M1 to the message M4 when the non NFC-equipped mobile apparatus is held over the NFC display 11A, and thereby, it is possible to prompt a user of the non NFC-equipped mobile apparatus to perform switching to a communication scheme which allows data communication also by the non NFC-equipped mobile apparatus.

### Main Effect of Third Embodiment

As described above, the display apparatus 1A according to the present embodiment determines, based on the detection signal of the touch panel 111, whether or not a mobile apparatus with which the NFC display 11A is touched has the NFC communication function, and when it is determined that the mobile apparatus has no NFC communication function, the display apparatus 1A notifies that the mobile apparatus has no NFC communication function. Thus, a user can be aware that the NFC display is touched with the non NFC-equipped mobile apparatus.

Alternatively, when the display apparatus 1A notifies a communication scheme which is other than the NFC and based on which the non NFC-equipped mobile apparatus is assumed to be able to communicate with the display apparatus 1A, a user may use the communication scheme to cause the display apparatus 1A to perform the data communication with the mobile apparatus.

Moreover, when the mobile apparatus 100 is held over the NFC display 11A, a process similar to that in the second embodiment is performed. Thus, in this case, effects similar to those in the second embodiment are obtained.

### Fourth Embodiment

Another embodiment of the present disclosure will be described below. Note that for the sake of description, members having the same functions as the members described in the embodiment are denoted by the same reference signs, and the description thereof will be omitted.

Unlike the second embodiment, the present embodiment assumes that an NFC communication unit 112 and an NFC controller 13 of a display apparatus 1A (that is, a NFC communication function of the display apparatus 1A) are disabled before an NFC display 11A is touched with a mobile apparatus 100. A control unit 14A of the present embodiment checks whether or not the NFC display 11A is touched with the mobile apparatus 100 by determining whether or not a touch panel 111 detects the mobile apparatus 100, and then, by determining whether or not the NFC communication is possible.

Next, with reference to FIG. 12, an example of a process in the display apparatus 1A according to the present embodiment will be described. FIG. 12 is a flow chart illustrating the example of the process in the display apparatus 1A according to the present embodiment. Note that the processes S1 to S4 and S12 are similar to those of the display apparatus 1A according to the second embodiment shown in FIG. 8, and thus, the description of thereof is omitted here. Moreover, a process in S21 is similar to that of the display apparatus 1A according to the third embodiment shown in FIG. 10, and thus, the description thereof is omitted here.

Specifically, as illustrated in FIG. 12, a terminal presence/absence determination unit 145 first determines whether or not the mobile apparatus 100 is detected by the touch panel 111 (S21, detection step).

If the response signal detection determination unit 145 determines that the mobile apparatus 100 is detected (if YES is determined in S21), the control unit 14A enables the NFC communication function of the display apparatus 1A (S31). Then, a response signal detection determination unit 141 causes the NFC controller 13 to transmit a request signal to detect the mobile apparatus 100 and checks whether or not the NFC controller 13 receives a response signal in response to the request signal from the mobile apparatus 100 (S1). Then, when the response is given by the mobile apparatus 100, the response signal detection determination unit 141 determines that the NFC communication with the mobile apparatus 100 is possible (determination step).

When the response signal detection determination unit 141 determines that the NFC communication with the mobile apparatus 100 is not possible (NO is determined in S), the control unit 14A disables the NFC communication function of the display apparatus 1A (S32). Next, when the response signal detection determination unit 141 determines that the NFC communication with the mobile apparatus 100 is not possible, it is assumed that the NFC communication function of the mobile apparatus 100 is disabled. Therefore, a notification control unit 144 causes the display unit 113 to notify that the NFC communication is not possible (S12; notification step).

Note that when the response signal detection determination unit 141 determines that the NFC communication with the mobile apparatus 100 is possible (YES is determined in S), the control unit 14A disables the NFC communication function of the display apparatus 1A (S33), processes in S2 to S4 may be performed. Moreover, when the touch panel 111 does not detect the mobile apparatus 100 (NO is determined in S21), the process in the detection step (S21) is repeated until the mobile apparatus 100 is detected.

According to the order of the processes of the present embodiment, the NFC communication function of the display apparatus 1A may be disabled until the touch panel 111 detects the mobile apparatus 100. Thus, according to the display apparatus 1A according to the present embodiment, it becomes possible to reduce power consumption by the display apparatus 1A until the mobile apparatus 100 is detected.

Note that in general, in the case of the NFC communication unit 112, when the mobile apparatus 100 is brought as close as a prescribed distance (several centimeters) to the NFC display 11A, it is possible to perform communication and detect the mobile apparatus 100. On the other hand, in the case of the touch panel 111, it is difficult to detect the mobile apparatus 100 unless the mobile apparatus 100 is brought closer to the NFC display than the prescribed distance. In the second embodiment, it is assumed that the NFC communication function of the display apparatus 1A is enabled, and detection determination by the NFC communication unit 112 is performed before the detection determination by the touch panel 111. Thus, in the second embodiment, as long as the NFC communication function of the mobile apparatus 100 is enabled, it is possible to securely detect the mobile apparatus 100 within a range in which the touch panel 111 cannot detect the mobile apparatus 100.

### Example of Actualization by Software

Control blocks (in particular, the control units 14 and 14A) of the display apparatuses 1 and 1A may be actualized by logic circuits (hardware) formed on, for example, integrated circuits (IC chips) or actualized by software by a Central Processing Unit (CPU).

In the latter case, the display apparatuses 1 and 1A each include a CPU configured to execute a command of a program as software for realizing each function, Read Only Memory (ROM) or memory (which are referred to as “recording medium”) in which the program and various types of data are stored in a computer (or CPU) readable manner, Random Access Memory (RAM) in which the program is to be expanded, and the like. The computer (or CPU) reads the program from the recording medium and executes the program to achieve the object of the present disclosure. As the recording medium, a “non-transitory tangible medium”, for example, a tape, a disk, a card, semiconductor memory, a programmable logic circuit, or the like may be used. The program may be supplied to the computer over any transmission medium (for example, communication network or broadcast wave) that is capable of transmitting the program. Note that, the present disclosure can be embodied also in a form of a data signal in which the program is realized by electronic transmission and which is embedded in a carrier wave.

### SUMMARY

A communication terminal (display apparatus 1, 1A) according to a first aspect of the present disclosure includes a communication unit (NFC communication unit 112) configured to perform near field communication (NFC communication), a detection unit (NFC controller 13, response signal detection determination unit 141, touch panel 111, touch panel controller 12, terminal presence/absence determination unit 145) configured to detect another terminal (mobile apparatus 100, non NFC-equipped mobile apparatus), a determination unit (communication mode determination unit 142, response signal detection determination unit 141) configured to determine, when the detection unit detects the another terminal, whether or not a specific type of communication (communication based on a P2P mode, NFC communication) with the another terminal via the communication unit is possible, and a notification unit (display unit 113, notification control unit 144) configured to, when the determination unit determines that the communication is not possible, notify that the communication is not possible.

According to the configuration, when it is determined that the specific type of communication with the another terminal detected by the detection unit is not possible via the communication unit for performing the near field communication, it is possible to notify a situation that the communication is not possible. Thus, it is possible to notify a user of the situation that the communication with the another terminal is not possible.

That is, in the case of a state where a specific type of communication function of a communication unit included in the another terminal is stopped or a state where communication of data by the communication unit of the another terminal is not possible, a user can be aware of the state. Thus, it becomes possible for a user to take a countermeasure to resolve the state. Moreover, it is possible to avoid a situation where a user cannot be aware of the state and stands by execution of the communication.

Moreover, in a communication terminal according to a second aspect of the present disclosure referring to the first aspect, the determination unit (communication mode determination unit 142) is preferably configured to determine whether or not bidirectional communication (communication based on the P2P mode) with the another terminal as the specific type of communication is possible.

According to the configuration, when the bidirectional communication with the another terminal is not possible, a user can be aware of that the bidirectional communication is not possible.

Moreover, in a communication terminal (display apparatus 1) according to a third aspect of the present disclosure referring to the first or second aspect, the detection unit (NFC controller 13) may be configured to output, to an outside, a signal for detecting the another terminal and to check whether or not a response to the signal is given to detect the another terminal.

With this configuration, detection of the another terminal may be performed based on the presence/absence of the response to the signal.

Moreover, in a communication terminal (display apparatus 1A) according to a fourth aspect of the present disclosure referring to the first or second aspect, the detection unit is a touch panel (111), and when the touch panel detects the another terminal (mobile apparatus 100) and when the determination unit (response signal detection determination unit 141) determines that the communication (NFC communication) is not possible, the notification unit preferably notifies that the communication is not possible.

When the touch panel detects the another terminal but the communication with the another terminal is not possible, the communication function of the communication unit included in the another terminal is highly possibly in a stopped state. With this configuration, it is notified that the communication is not possible in the above-described case, and therefore, a user can be aware of the high possibility of the stopped state.

Moreover, in a communication terminal according to a fifth aspect of the present disclosure referring to the first, second, or fourth aspect, the detection unit is a touch panel, the communication terminal further includes a communication function presence/absence determination unit (terminal presence/absence determination unit 145) configured to determine, based on a detection signal denoting that the touch panel detects the another terminal, whether or not the another terminal has a communication function (NFC communication function) which enables communication with the communication unit, and when the communication function presence/absence determination unit determines that the another terminal does not have the communication function, the notification unit preferably notifies that the another terminal does not have the communication function.

When the another terminal does not have the communication function, the communication terminal cannot communicate with the another terminal via the communication unit. With this configuration, when it is determined, based on the detection signal of the touch panel, that the another terminal does not have the communication function, it is notified that the another terminal does not have the communication function. Therefore, a user can be aware that the another terminal does not have the communication function, and can take a measure to communicate with the another terminal without using the communication unit.

Moreover, a method for controlling a communication terminal according to a sixth aspect of the present disclosure is a method for controlling a communication terminal including a communication unit configured to perform near field communication, the method including a detection step of detecting another terminal, a determination step of determining, when the another terminal is detected in the detection step, whether or not a specific type of communication with the another terminal via the communication unit is possible, and a notification step of notifying, when it is determined in the determination step that the communication is not possible, that the communication is not possible.

According to the method, an effect similar to that of the first aspect is obtained.

Moreover, the communication terminal according to each aspect of the present disclosure may be realized by a computer. In this case, a communication control program of a communication terminal and a computer-readable recording medium storing the communication control program are also within the scope of the present disclosure. The communication control program causes the computer to operate as each component (software element) included in the communication terminal and realizes the communication terminal by the computer.

Difference from Invention of Prior Art Document

A communication terminal according to one aspect of the present disclosure and a control method thereof are different from the invention according to the prior art document in the following points.

That is, in the technique of PTL 1, whether a contactless IC card is identical is checked before and after the transaction whereas in one aspect of the present disclosure, it is determined whether or not a specific type of communication with another terminal via the communication unit is possible.

Moreover, in a technique of PTL 2, a mobile apparatus receives information regarding a state of an apparatus of a communication partner (image forming apparatus) and displays the state. On the other hand, in one aspect of the present disclosure, when it is determined that a specific type of communication with another terminal via the communication unit is not possible, a communication terminal (for example, a display apparatus) as an apparatus over which the another terminal (for example, mobile apparatus) is held notifies that the specific type of communication is not possible.

Moreover, in the technique of PTL 2, information to be displayed is information regarding a state of the image forming apparatus, for example, the state of the image forming apparatus being “normal”, “incoming”, or “error”. On the other hand, it can be said that a content to be notified by the communication terminal according to the one aspect of the present disclosure is determination that the specific type of communication with the another terminal via the communication unit is not possible and information regarding the another terminal (for example, mobile apparatus), or information regarding the relationship between the communication terminal and the another terminal.

Moreover, when the detection unit is a touch panel in the one aspect of the present disclosure, the present disclosure is, also in this regard, different from the techniques of PTL 1 and PTL 2.

### Note

The present disclosure is not limited to the embodiments described above, and various modifications may be made within the scope of the claims. The present disclosure also encompasses, in its technical scope, any embodiment derived by combining technical means disclosed in differing embodiments. Further, it is possible to form a new technical feature by combining the technical means disclosed in the respective embodiments.

### CROSS-REFERENCE OF RELATED APPLICATION

The present disclosure contains subject matter related to that disclosed in Japanese Priority Patent Application JP 2016-197470 filed in the Japan Patent Office on Oct. 5, 2016, the entire contents of which are hereby incorporated by reference.

### REFERENCE SIGNS LIST

1, 1A DISPLAY APPARATUS (COMMUNICATION TERMINAL)
12 TOUCH PANEL CONTROLLER (DETECTION UNIT)
13 NFC CONTROLLER (DETECTION UNIT)
100 MOBILE APPARATUS (ANOTHER TERMINAL)
111 TOUCH PANEL (DETECTION UNIT)
112 NFC COMMUNICATION UNIT (COMMUNICATION UNIT)
113 DISPLAY UNIT (NOTIFICATION UNIT)
141 RESPONSE SIGNAL DETECTION DETERMINATION UNIT (DETECTION UNIT, DETERMINATION UNIT)
142 COMMUNICATION MODE DETERMINATION UNIT (DETERMINATION UNIT)
144 NOTIFICATION CONTROL UNIT (NOTIFICATION UNIT)
145 TERMINAL PRESENCE/ABSENCE DETERMINATION UNIT (DETECTION UNIT, COMMUNICATION FUNCTION PRESENCE/ABSENCE DETERMINATION UNIT)

1. A communication terminal comprising:
a communication unit configured to perform near field communication;
a detection unit configured to detect another terminal;
a determination unit configured to determine, when the detection unit detects the another terminal, whether or not a specific type of communication with the another terminal via the communication unit is possible; and
a notification unit configured to, when the determination unit determines that the communication is not possible, notify that the communication is not possible.

2. The communication terminal according to claim 1, wherein
the determination unit is configured to determine whether or not bidirectional communication with the another terminal as the specific type of communication is possible.

3. The communication terminal according to claim 1, wherein
the detection unit is configured to output, to an outside, a signal for detecting the another terminal and to check whether or not a response to the signal is given to detect the another terminal.

4. The communication terminal according to claim 1, wherein
the detection unit is a touch panel, and
when the touch panel detects the another terminal and when the determination unit determines that the communication is not possible, the notification unit notifies that the communication is not possible.

5. The communication terminal according to claim 1, wherein
the detection unit is a touch panel,
the communication terminal further includes a communication function presence/absence determination unit configured to determine, based on a detection signal denoting that the touch panel detects the another terminal, whether or not the another terminal has a communication function which enables communication with the communication unit, and
when the communication function presence/absence determination unit determines that the another terminal does not have the communication function, the notification unit notifies that the another terminal does not have the communication function.

6. A method for controlling a communication terminal including a communication unit configured to perform near field communication, the method comprising:
a detection step of detecting another terminal;
a determination step of determining, when the another terminal is detected in the detection step, whether or not a specific type of communication with the another terminal via the communication unit is possible; and
a notification step of notifying, when it is determined in the determination step that the communication is not possible, that the communication is not possible.
